(19) United States
(12) Patent Application Publication
(10) Pub. No.: US 2015/0356642 A1
(43) Pub. Date: Dec. 10, 2015

(54) SYSTEMS AND METHODS FOR PROCESSING REQUESTS FOR MERCHANT INFORMATION

(71) Applicant: JP Communications, Inc., Los Angeles, CA (US)

(72) Inventor: Jason Prescott, Los Angeles, CA (US)

(21) Appl. No.: 14/571,261

(22) Filed: Dec. 15, 2014

Related U.S. Application Data
(63) Continuation of application No. PCT/US13/45729, filed on Jun. 13, 2013.
(60) Provisional application No. 61/659,369, filed on Jun. 13, 2012.
(60) Provisional application No. 61/659,371, filed on Jun. 13, 2012.

(51) Int. Cl. G06Q 30/02

(52) U.S. Cl. CPC G06Q 30/0282

(57) ABSTRACT

A software method and system for a merchant to demonstrate profile authenticity within an online business to business community that connects buyers (e.g., retailers, importers, distributors, auctioneers, drop shippers, resellers, flea marketers, wholesalers) to suppliers (e.g., manufacturers, exporters, importers, wholesalers). In such an online community, profile authenticity and business verification is critical for members to trust each other and consider a new trade relationship. Such trust can be developed and assured through a merchant profile verification process which examines the authenticity of a merchant's corporate information via public record review and interviews with company officers. Verified merchants are awarded the privilege to display an icon that assures merchant profile trustworthiness on their community profile, community product postings, and on other webpages outside of the online business community. The described authentication icon offers a seal of verification to merchants, thus enabling them to conduct business with higher assurance on a wholesale ecommerce trade platform, namely TopTenWholesale.com. Included in this patent are the methods of screening, software features, and processes.

### CROSS-REFERENCE TO RELATED APPLICATIONS

This application claims the benefit of U.S. Provisional App. Ser. No. 61/659,369, filed on Jun. 13, 2012, and U.S. Provisional App. Ser. No. 61/659,371, filed on Jun. 13, 2012; all of the above applications are hereby incorporated by reference.

### RELATED FIELD

Various embodiments of the present invention relate generally to methods and computerized processes for certifying the identity and legitimacy of a merchant profile listing within a business to business online community, as well as any other website where the merchant has an online presence.

### BACKGROUND

All business relies on the trust and integrity between the buyer and the seller. The integrity of the buyer is based upon timely payment. The integrity of the seller is based on reputation. Conveying a reputation of trust without an agreed upon unit of proof is difficult and requires additional effort to demonstrate. Every buyer, at some point and at some level, has purchased a product below quality expectations. Because of this ubiquitous phenomenon, buyers exercise caution when purchasing from a new or unknown seller until company trust is established. The degree of caution greatly increases when additional risk factors such as purchasing large scale orders, purchasing from companies residing in obscure or long distance locations, or purchasing through online internet portals are present in the potential transaction. With the trend of commerce migrating toward ecommerce—where business introductions and transactions occur through online portals—certifications of trustworthiness are needed for companies to operate confidently. Without such certifications, a buyer's rightful sense of caution inhibits and, in some cases, unnecessarily prohibits business transactions with legitimate suppliers.

Historically, to overcome a buyer's hesitancy, companies worked long and hard to develop a reputation of integrity. However, proof of integrity and reputation has been difficult to establish as well as demonstrate to new buyer introductions. In addition, communicating such proof of integrity and reputation is difficult as well. Thirdly, because of the prevalence of fraudulent companies, many wholesale or supplier companies experience additional disadvantages due to the inability to display proof of company integrity. There are millions of websites that portray the image of a reputable supplier or business, when in fact, this is a mere smoke and mirror tactic trying to create a credible perception when the reality is illusory. Conversely, a corporate buyer is looking to purchase quality goods at lowest price in order to maximize their company profits. However, selecting the right merchant can be risky. Clearly, the need for a merchant profile certification and certification process are needed for the supplier to demonstrate trustworthiness and authenticity and for the buyer to have confidence when selecting a merchant to purchase product from.

### SUMMARY

A method and a system for processing requests for merchant information and for conducting a merchant profile verification are disclosed. The system includes an enrollment into the TopTenWholesale web portal FIG. 1A Block 100, a profile submission process and premium membership enrollment process FIG. 1A 102, a merchant profile verification process FIG. 1B 120, and award of a merchant profile authentication icon display FIG. 1D 138, called the Supplier Pass®, and the privilege to post such icon on all merchant profile and product postings within the TopTenWholesale portal as well as other merchant website postings outside of the TopTenWholesale portal (where in some embodiments, such posts are automatically updated when the profile is updated as shown in FIG. 1D at Block 140).

Before applying for the Supplier Pass® verification process, merchants must register Block 100 into the system where certain information is obtained about the merchant and stored within the system. Upon registration, merchants comply with predetermined terms and conditions which are used to govern the actions and postings within the system. Such terms and agreements are made available during and after registration. Increased capabilities and privileges are granted to merchants who are awarded Premium Member status. Premium Member profiles are placed in a Supplier Pass® Application queue Block 112, and upon approval of the Supplier Pass® profile verification process Blocks 128 to 136, a notification of successful verification may be sent to the merchant (e.g., as shown in FIG. 2), and the merchant can thereafter display the Supplier Pass® icon Block 138. This icon FIG. 3 represents merchant profile authenticity, and integrity as a legitimate business operation. This icon is designed to accelerate trust between a buyer and seller advertising, communicating, or initiating a transaction through the TopTenWholesale.com portal.

Various embodiments are directed to an electronic automated process for profile verification. Upon completing premium membership status, a company is submitted for Supplier Pass® Verification. The verification process is reviewed by authentication agents who conduct several reviews as well as interviews with company staff.

### BRIEF DESCRIPTION OF DRAWINGS

Various embodiments disclosed herein are described in detail with reference to the following figures:

FIG. 1A is a block diagram depicting the actions of a merchant applying for a Supplier Pass®.

FIG. 1B is a block diagram depicting the actions of the TopTenWholesale Account Administrator processing a merchant's Supplier Pass® application

FIG. 1C is a block diagram depicting the actions of the Verification Agency conducting a profile verification review of a merchant's Supplier Pass® application

FIG. 1D is a block diagram depicting the actions of the TopTenWholesale Account Administrator awarding a merchant's Supplier Pass®

FIG. 2 Notification Email

FIG. 3 Image of Supplier Pass® Icon

FIG. 4 Screenshot of Supplier Pass® Approved Company Profile Image

FIG. 5 Screenshot of Supplier Pass® Approved Company Account Home Page

FIG. 6 Screenshot of Supplier Pass® Approved Product Listing

FIG. 7 is a block diagram of an exemplary network topology which may be used for merchant profile verification according to embodiments of the present invention.

FIG. 8 is a flow diagram illustrating an exemplary process of returning merchant information according to embodiments of the present invention.

FIG. 9 is a block diagram illustrating an exemplary merchant verification authority according to embodiments of the present invention.

FIG. 10 is a flow diagram illustrating an exemplary process of merchant profile verification according to embodiments of the present invention.

FIG. 11 shows an example device suitable for use in some example embodiments.

### DETAILED DESCRIPTION

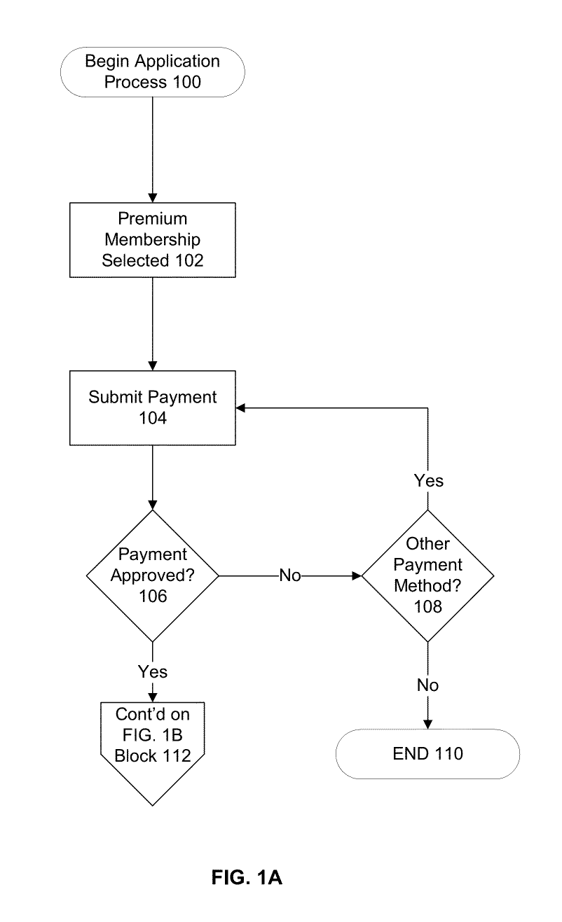

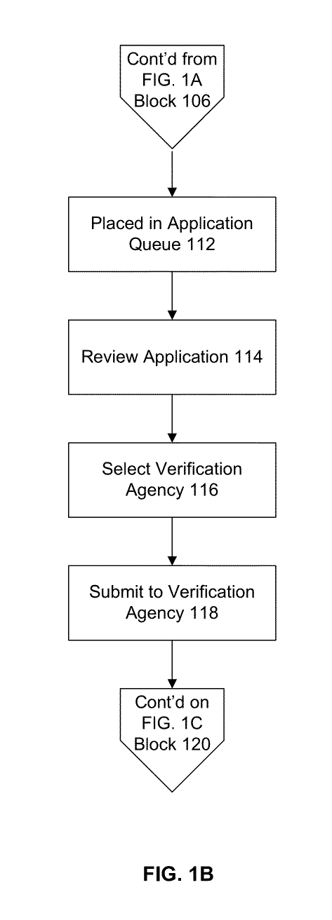

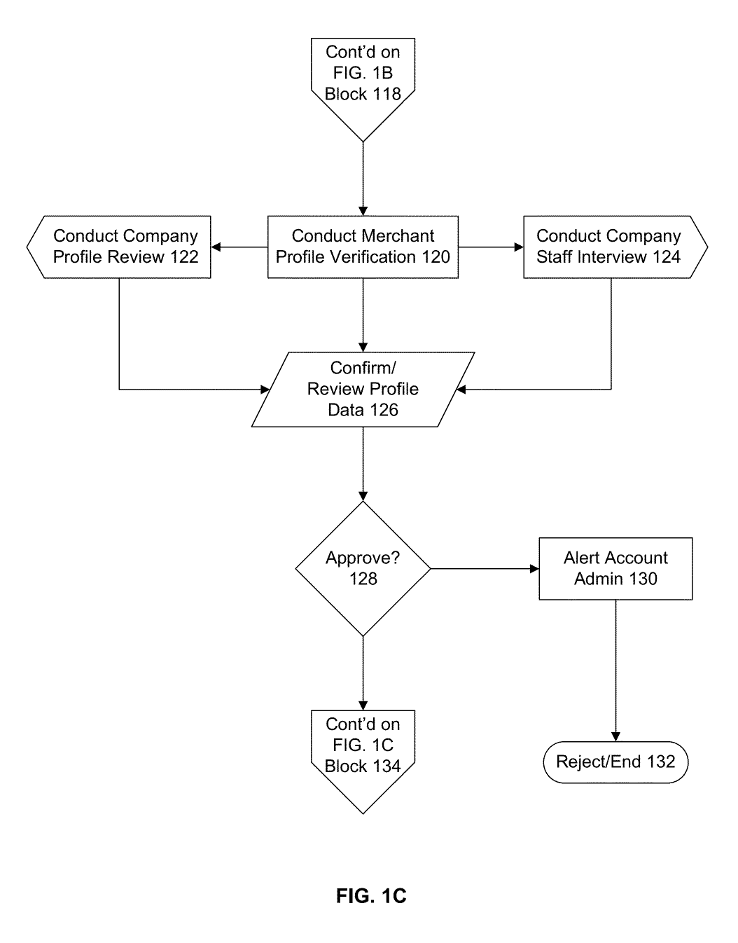

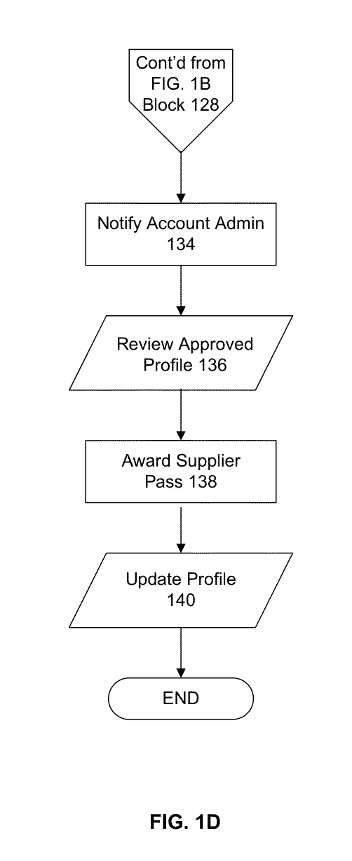

FIGS. 1A to 1D illustrate an exemplary process and control flow within the process according to embodiments of the present invention. The system and method of operation based on the illustrative configurations may vary as to the details of its configuration and operation, and the illustrations should not be construed as limiting the basic concepts to a specific software configuration.

Referring to FIGS. 1A to 1D, various embodiments generally comprise an online semi-automated company profile verification process as illustrated. Some embodiments include a plurality of software modules sharing common data and subsequent profile data correction with the programs to be executed using data processors, or workstations of individuals or businesses.

Process activities are separated into the activities of the acting party. FIG. 1A depicts the actions conducted by merchant initiating the application process. FIG. 1B depicts the activities of the TopTenWholesale Account Administrator accepting the application and assigning the profile verification agency—an internal department or third party profile verification agency—and submitted for profile review. FIG. 1C depicts the profile review activities conducted by the selected verifying agency. FIG. 1D depicts the final authorization and award activities of the TopTenWholesale Account Administrator.

Referring to FIG. 1A, a merchant initiates the Supplier Pass® application process. Using a workstation, a merchant is able to initiate the application process by signing up as a member to TopTenWholesale.com in Block 100. The sign up process is automated and employs a template questionnaire. The questionnaire prompts the merchant via a HyperText Markup Language HTML page on the internet to enter basic information about the merchant's company profile. The requested basic merchant information includes the username, password, company name, address of the business, the type of business, the goods and services sold by the business, the business's country of origin, etc.

Referring to FIG. 1A, if a client company has selected “Premium Membership” on the template questionnaire/application/data collection form (at block 102), the questionnaire then prompts the merchant via an HTML page on the internet to enter business owner, basic company contact information, website, e-mail, and payment information. In some embodiments, the requested information includes the names and titles of the owners and officers of the business and the name of the business's bank.

Referring to FIG. 1A Block 104, payment is required during the application process. Block 104 prompts the merchant via an HTML page on the internet to enter a valid credit card number. The merchant credit card payment is processed over the internet. The requested credit card types include the most popular credit cards currently available. In case credit payment is declined in Block 108, the merchant applicant is asked for an alternate credit payment method and resubmitted for payment in Block 104. If the merchant is unable to produce payment, then the application process ends at Block 110.

Upon payment verification in Block 106, the application progresses to an Account Administrator preliminary application review queue in Block 112. The TopTenWholesale Account Administrator has the authority and discretion to service applications in the queue on a First-In-First-Out or Priority basis. In Block 114, the TopTenWholesale Account Administrator reviews the application to assure proper data content. Upon completion, in Block 116 the TopTenWholesale Account Administrator selects the verification agency that will conduct the merchant profile verification review and in Block 118 submits the application to the selected verification agency.

Referring to FIG. 1C Block 120, the verification agency initiates the merchant profile verification process, which includes conducting a company profile review (Block 122) and conducting a company staff interview (Block 124). At Block 122, a company profile review is conducted. In some embodiments, the items under review include basic company information, contact information, other information, and social networking information. Basic company information may include, for example, the name of the company, a listing of DBAs, a company description (e.g., the company's stated product or service line), the company's website URL, the names and titles of the owners and officers of the company, the brands of products being sold, the type of business (e.g., manufacturer, wholesaler, reseller, dropshipper, trading company, government, etc.), the type of business entity (e.g., corporation, sole proprietorship, partnership, limited liability company, etc.), the year the business was founded, the total number of company employees, the business's registration number, the issuing authority, the issue and expiration dates, and the type/amount of registered capital. Contact information may include, for example, the company's country, address, city, and state. Other information may include, for example, annual sales volume, the location of the company's primary markets (e.g., North America, Europe, Africa, Oceania, etc.), quality management information (e.g., BPR, ISO 15504-4: 2005, OQM, QFD, Taguchi Methods, TRIZ, Zero Defect Program, etc.), number of quality control employees, certifications (e.g., HACCP, ISO 14001:2004, ISO 17799, TL 9000, etc.), a listing of owned patents, the business's Data Universal Numbering System number (“DUNS” number), and a Better Business Bureau® Accreditation URL. Social Networking Information may include, for example, a listing of URLS linked to accounts of associated social media websites (Facebook®, Twitter®, and LinkedIn®, etc.). Various other aspects of the business may also be verified according to embodiments of the present invention. Referring to Block 124, a verification agent interviews with the owners and officers of the merchant company to double verify merchant profile information.

Information is confirmed through a combination of data extracted from various independent sources such as the internet, business registries, etc. and from personal interviews of merchant company staff and officers. The verification agent confirms or revises merchant profile data in Block 126. Based upon the review results, the verification agent approves or declines the merchant profile based upon research findings, Block 128. In the case that an application that cannot be verified or, has critical discrepancies, the TopTenWholesale Account Administrator is alerted in Block 130, and the process is terminated in Block 132 with appropriate action is taken by TopTenWholesale staff. In some embodiments, this action includes sending a notification to the merchant indicating that their business could not be verified.

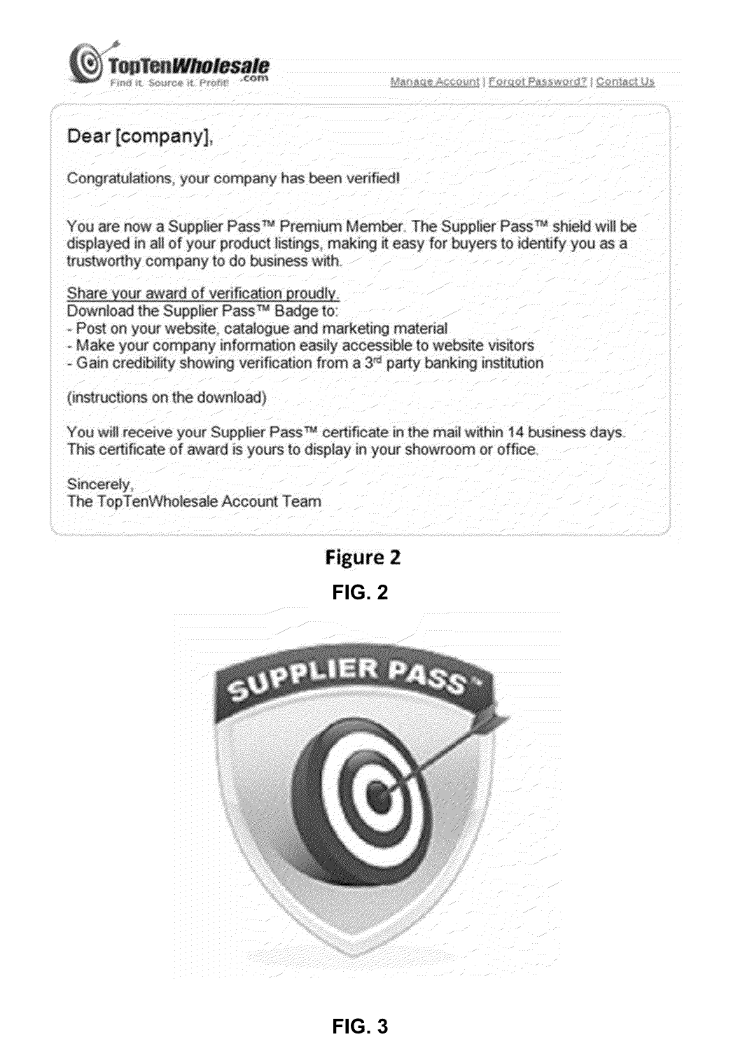

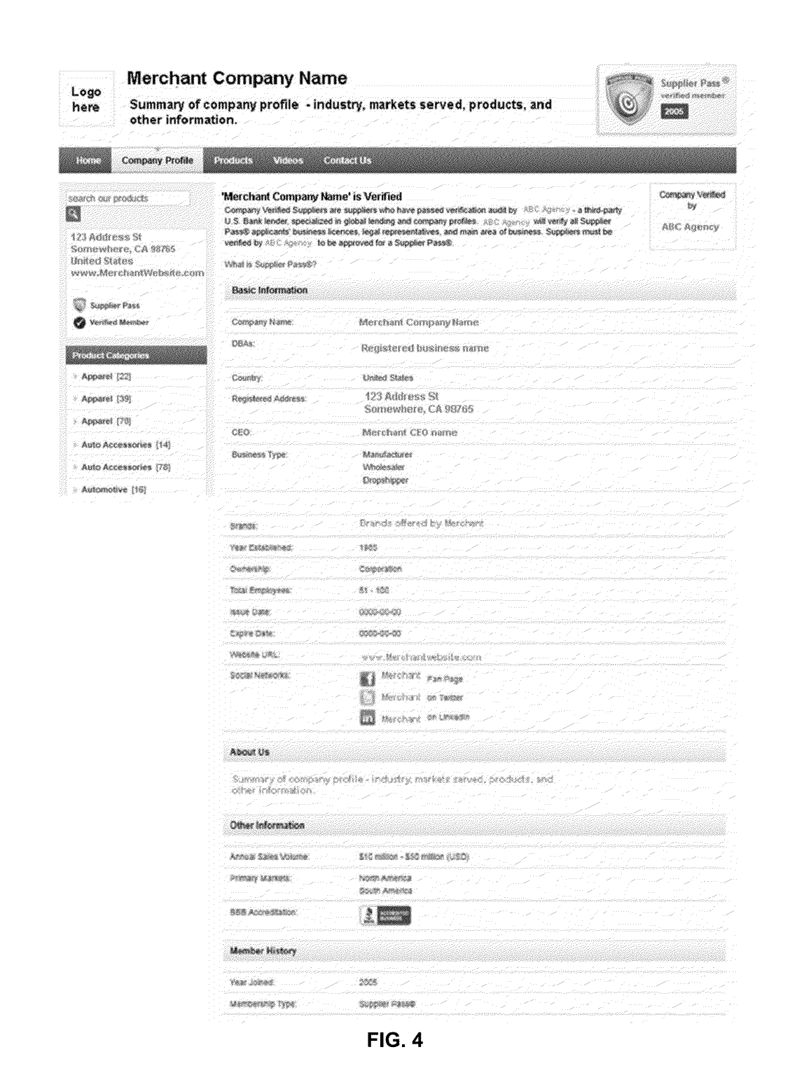

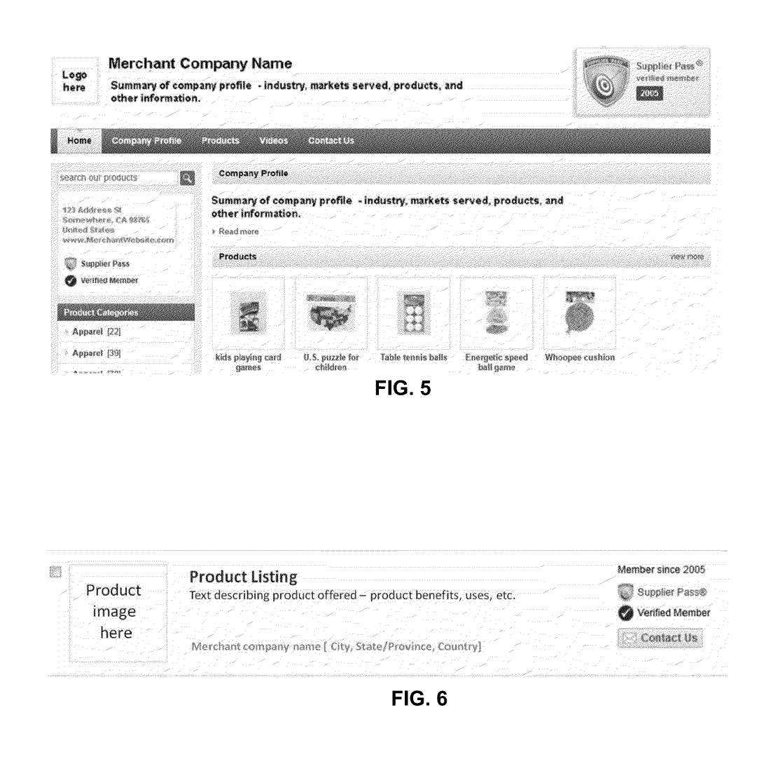

If the merchant profile information has been approved by the verification agent in Block 128, the TopTenWholesale Account Administrator is notified of the merchant's completed profile review in Block 134 and conducts a final application review in Block 136. The Account Administrator authorizes approval and awards the Supplier Pass® Shield to the merchant in Block 138. The merchant is automatically notified by email FIG. 2 and the merchant profile and postings are automatically updated with the Supplier Pass® icon Block 140. FIG. 3 shows the Supplier Pass® icon. FIGS. 4 to 6 depict examples of a Supplier Pass® icon posted to the merchant profile, webpage, and product listing,

The Supplier Pass® shield will automatically appear on the merchant's TopTenWholesale profile page and other TopTenWholesale content postings. In addition, merchant unique html code that displays the Supplier Pass® shield on the merchant's homepage is made available to the merchant. The merchant's web developer can use this html code to display the Supplier Pass® shield icon on their own website or homepage.

The Supplier Pass® shield will be displayed for up to 1 year or until membership terminates. Upon membership expiration, all Supplier Pass® shield icons—inside or outside of the TopTenWholesale.com web portal—will cease to be displayed. Prior to or upon membership expiration, the merchant can reapply for the Supplier Pass® process starting at Block 104. The new expiration date will be no sooner than 1 year after the expiration of the current membership.

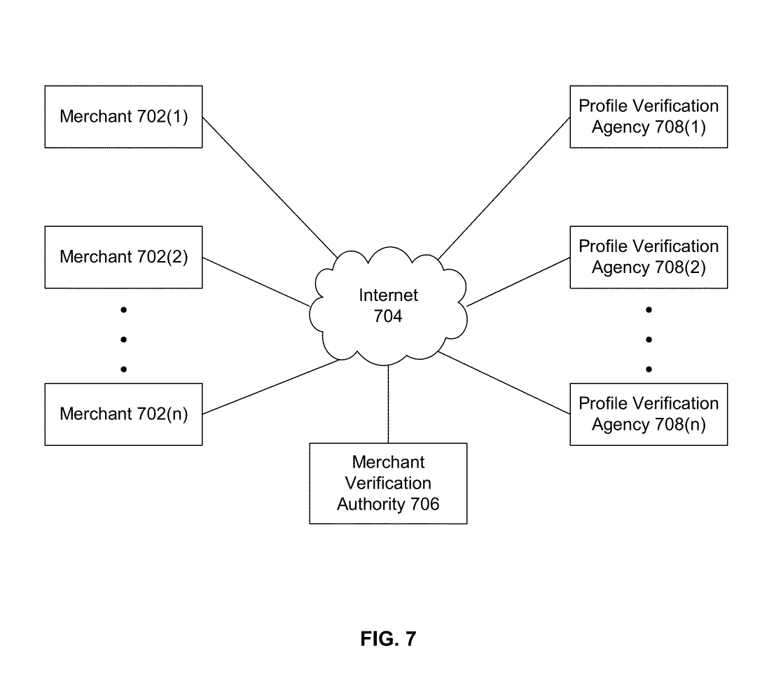

FIG. 7 is a block diagram of an exemplary network topology which may be used for merchant profile verification according to embodiments of the present invention. As illustrated by this figure, one or more merchants 701(1)-702(n) may interface with a merchant verification authority 706 via a network connection, such as the Internet 704. The merchant verification authority 706 may receive from a merchant 702 a request for merchant profile verification or a request for information related to another merchant's business.

When the merchant verification authority 706 receives a request for merchant profile verification, according to some embodiments, the merchant verification authority 706 may utilize a set of outside profile verification agencies 708(1)-708(n) in order to perform all or a portion of that merchant's profile verification. A correspondence map stored within the merchant verification authority 706 may be used to map particular merchants 702 requesting merchant profile verification to corresponding profile verification agencies 708. The mapping can be based upon one or more inputs previously provided by the merchant (including, without limitation, a type of business, a type of business entity, reported revenues, a state of incorporation, geographic locations of the business's facilities, operations, or its headquarters). In some embodiments, the total workload of various profile verification agencies 708 may also be used in order to balance the tasks distributed among multiple profile verification agencies 708. Note that the merchant verification authority 706 itself may perform all or a portion of the merchant profile verification according to embodiments of the present invention.

When the merchant verification authority 706 receives a request for information related to another merchant's business, according to some embodiments, the type of information returned may depend at least in part upon the class of membership associated with the requesting merchant.

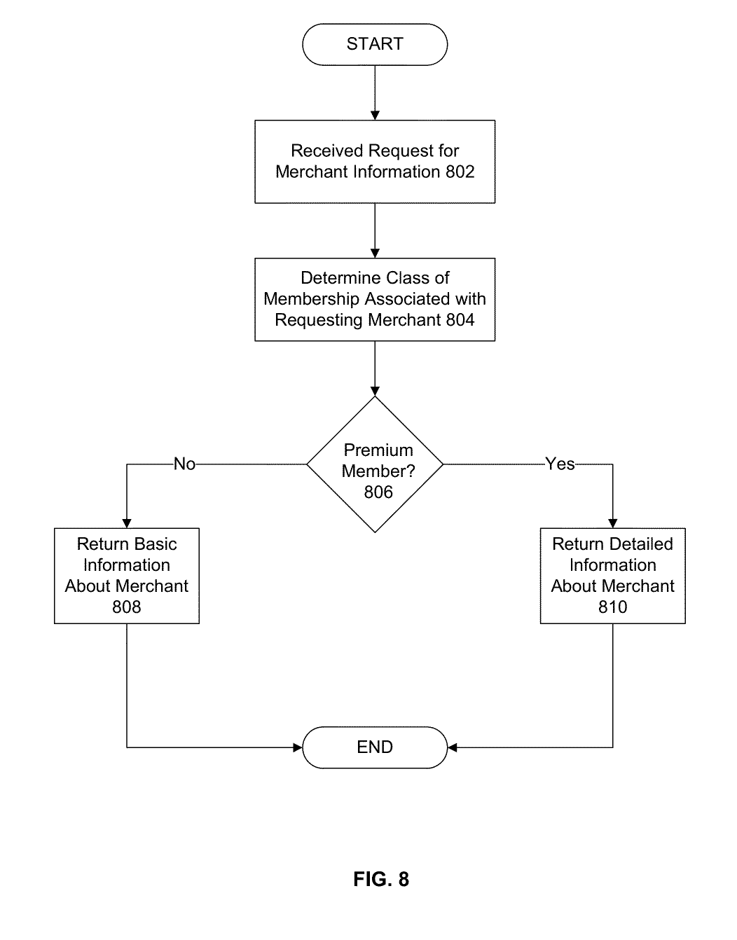

FIG. 8 is a flow diagram illustrating an exemplary process of returning merchant information according to embodiments of the present invention. At block 802, a request for merchant information is received, for example, at the merchant verification authority 706. The class of membership associated with the requesting merchant is then determined at block 804. This may be accomplished, for example, by referencing the membership status of the requesting merchant in a data structure associated with the requesting merchant's account (e.g., a file, database, table, list, tree, stack, array, queue, heap, etc.) Note also that while the embodiment depicted in FIG. 8 utilizes only “premium” and “basic” memberships, it will be appreciated that any additional types or alternative types of memberships may also be defined according to embodiments of the present invention. For example, in embodiments utilizing a four-tier membership plan, basic, bronze, silver, and gold classes of memberships may be utilized in the alternative.

In some embodiments, the type, amount or quality of information returned may depend at least upon the class of membership associated with the requesting merchant. For example, in the embodiment depicted by FIG. 8, at decision block 806, if a determination is made that the requesting merchant is not a premium member, basic information about the requested merchant may be returned at block 808. The basic information may include, for example, company name, DBA's, Country, CEO name, registered address, and business type.

Conversely, if a determination is made that the requesting merchant is a premium member, detailed information about the merchant may be returned at block 810. In some embodiments, the detailed information may include the basic information as well as, for example, information reported on the business from a third-party business or credit agency such at the Better Business Bureau® or Dun & Bradstreet®, a listing of professional and industrial certifications and licenses held by the business its various employees, employee information (e.g., the merchant's total number of employees), financial information concerning the merchant and/or its various subsidiaries (e.g., balance sheets, income statements, corporate prospectus, quarterly reports, etc.), or associated online accounts listed on professional or social media websites (e.g., LinkedIn®, FaceBook®, Twitter®, etc.).

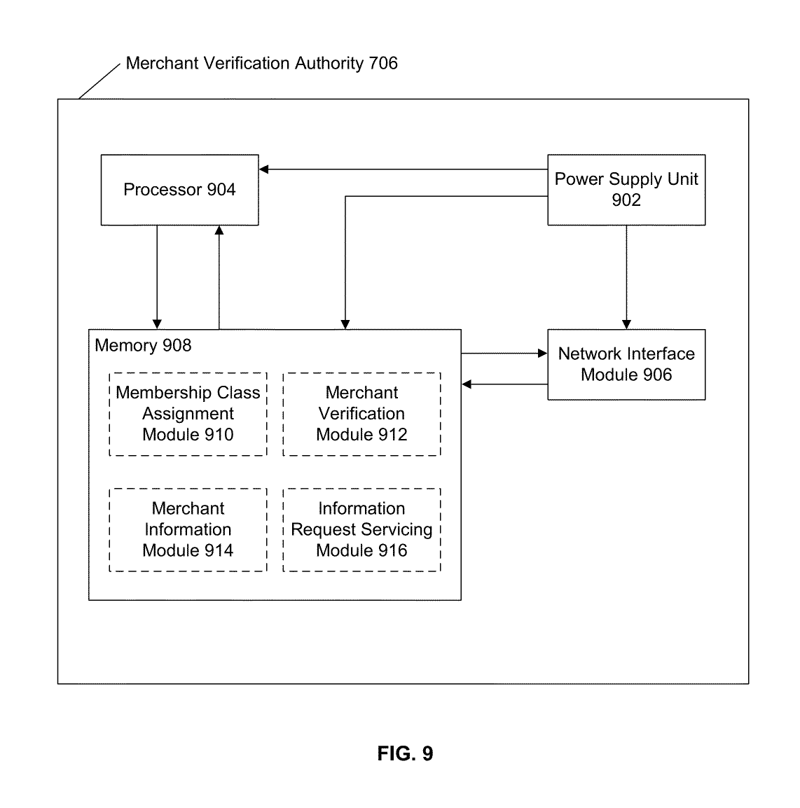

FIG. 9 is a block diagram illustrating an exemplary merchant verification authority 706 according to embodiments of the present invention. As depicted by the figure, the exemplary merchant verification authority 706 may include a power supply unit 902, one or more processors 904, a network interface module 906, and memory 908.

A power supply module 902 provides a source of power to the various components disposed within the merchant verification authority 706. In some embodiments, power is supplied externally by one or more conductive wires, for example, from a power cable or a serial bus cable. In other embodiments, a battery may be used as a source of power.

One or more processors 904 are adapted to execute sequences of instructions by loading and storing data to the memory 908. Possible instructions include, without limitation, instructions for data conversions, formatting operations, communication instructions, and/or storage and retrieval operations. Additionally, the one or more processors 904 may comprise any type of digital processing devices including, for example, reduced instruction set computer processors, general-purpose processors, microprocessors, digital signal processors, gate arrays, programmable logic devices, array processors, and/or application-specific integrated circuits. Note also that the one or more processors 904 may be contained on a single unitary IC die or distributed across multiple components.

One or more network interface modules 906 may be used to facilitate network communications with various network devices over a connected network (e.g., communications between merchants 702, and the merchant verification authority 706, or communications between the merchant verification authority 706 and the profile verification agencies 708).

While communications between the merchants 702, the merchant verification authority 706, and the profile verification agencies 708 may occurring via the Internet 704, it is to be understood that any type of networking medium and/or networking protocol may be used in the alternative (e.g., cellular networks, fiber-optic networks, cable networks, satellite networks, wireless networks, serial bus networks, etc.), and further, that the network connection between a merchant 702 and the merchant verification authority 706 may be a different type of network connection that that between the merchant verification authority 706 and a profile verification agency 708. Additionally, any type of network configuration or network topology may be used in accordance with the scope of various embodiments (e.g., personal area networks, metropolitan area networks, wide area networks, direct connection networks, star networks, ring networks, etc).

Memory 908 comprises any type of module adapted to enable digital information to be stored, retained, and retrieved. Additionally, memory 908 may comprise any combination of volatile and non-volatile storage devices, including without limitation RAM, DRAM, SRAM, ROM, and/or flash memory. Note also that the memory 312 may be organized in any number of architectural configurations utilizing, for example, registers, memory caches, data buffers, main memory, mass storage, and/or removable media.

In some embodiments, memory 908 further includes a set of one or more modules: a membership class assignment module 910 for assigning a class of membership to a particular online account, a merchant verification module 912 for initiating or performing merchant profile verification, a merchant information module 914 adapted to store data (and/or references to data) pertaining to various merchants, and an information request servicing module 916 adapted to service information requests submitted from various merchants. As stated above and with reference to FIG. 8, the type of information returned may depend at least in part upon the class of membership associated with a requesting merchant. Note that while membership class assignment module 910, merchant verification module 912, merchant information module 914, and information request servicing module 916 are depicted as software components stored within memory 908, it will be understood that any or all of such modules may be implemented as any combination of software, firmware, or hardware according to embodiments of the present invention.

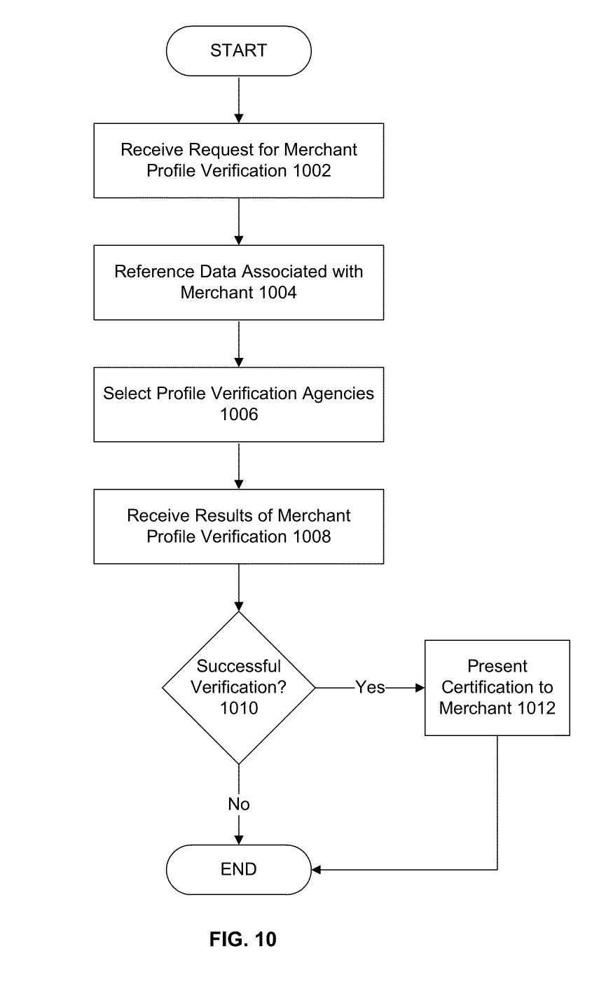

FIG. 10 is a flow diagram illustrating an exemplary process of merchant profile verification according to embodiments of the present invention. At block 1002, an electronic request for merchant profile verification is received from a merchant. In some embodiments, the electronic request for merchant profile verification may also include a payment or a confirmation of payment according to embodiments of the present invention.

At block 1004, a set of data associated with the merchant is referenced. In some embodiments, this data may include data presented by the merchant upon initial registration. In some embodiments, the data may include data submitted by the merchant in one or more online forms or questionnaires subsequently provided to the merchant by the merchant verification authority.

At block 1006, a set of one or more profile verification agencies may then be selected to conduct all or a portion of the merchant profile verification. The selection may be based at least in part upon the set of referenced data. For example, if a merchant's type of business is “hardware supply,” one or more profile verification agency specialized for hardware supply companies may be selected. In some embodiments, various tasks associated with merchant profile verification may be split or distributed among multiple profile agencies to facilitate faster verification processing times. Note also that in some embodiments, the merchant verification authority may itself handle all or a portion of the tasks associated with merchant profile verification.

At block 1008, results of the merchant profile verification are received from the one or more profile verification agencies. At decision block 1010, it is determined whether the verification of the merchant was successful. If the results indicate successful merchant profile verification, an electronic certification may then be presented to said merchant. Otherwise, a notice may be sent to the merchant indicating that the verification was not successful, and optionally, a set of reasons why the verification was not successful. The process then ends.

According to some embodiments, the electronic certification may be presented in the form of a downloadable program, code (e.g., html code), or script, which may be used by the merchant to display an electronic certification icon within one or more webpages. In some embodiments, the code may also create a link or selectable region which, when actuated, will redirect a requesting merchant to a webpage containing merchant information. In alternative embodiments, the code may simply link to a downloadable file containing merchant information.

In some embodiments, the type, amount or quality of information returned may depend at least in part upon a class of membership associated with the requesting merchant. For example, if a merchant who is a basic member clicks on an electronic certification icon, he may be redirected to a webpage merely containing basic information. However, if a merchant who is a premium member clicks on the same electronic certification icon, he may be directed to a webpage containing both basic information as well as detailed information. As stated above, the detailed information may include, without limitation, information reported on the business from a third-party business or credit agency such at the Better Business Bureau® or Dun & Bradstreet®, a listing of professional and industrial certifications and licenses held by the business its various employees, employee information (e.g., the merchant's total number of employees), financial information concerning the merchant and/or its various subsidiaries (e.g., balance sheets, income statements, corporate prospectus, quarterly reports, etc.), or associated online accounts listed on professional or social media websites (e.g., LinkedIn®, FaceBook®, Twitter®, etc.).

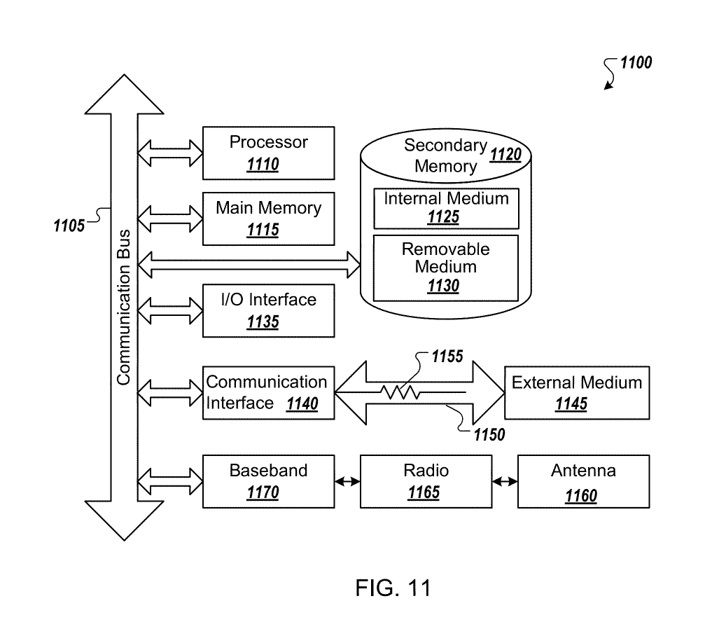

FIG. 11 shows an example device suitable for use in some example embodiments. Device 1100, a wired and/or wireless device, may be used in connection with various embodiments described herein. For example the device 1100 may be used as or in conjunction with one or more of the mechanisms or processes described above, and may represent components of server(s), user system(s), and/or other devices described herein. The device 1100 can be a server or any conventional personal computer, or any other processor-enabled device that is capable of wired or wireless data communication. Other computer systems and/or architectures may be also used, as will be clear to those skilled in the art.

The device 1100 preferably includes one or more processors, such as processor 1110. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 1110. Examples of processors which may be used with device 1100 include, without limitation, the Pentium® processor, Core i7® processor, and Xeon® processor, all of which are available from Intel Corporation of Santa Clara, Calif.

The processor 1110 is preferably connected to a communication bus 1105. The communication bus 1105 may include a data channel for facilitating information transfer between storage and other peripheral components of the device 1100. The communication bus 1105 further may provide a set of signals used for communication with the processor 1110, including a data bus, address bus, and control bus (not shown). The communication bus 1105 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/5-100, and the like.

Device 1100 preferably includes a main memory 1115 and may also include a secondary memory 1120. The main memory 1115 provides storage of instructions and data for programs executing on the processor 1110, such as one or more of the functions and/or modules discussed above. It should be understood that programs stored in the memory and executed by processor 1110 may be written and/or compiled according to any suitable language, including without limitation C/C++, Java, JavaScript, Pearl, Visual Basic, .NET, and the like. The main memory 1115 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 1120 may optionally include an internal memory 1125 and/or a removable medium 1130, for example a floppy disk drive, a magnetic tape drive, a compact disc (CD) drive, a digital versatile disc (DVD) drive, other optical drive, a flash memory drive, etc. The removable medium 1130 is read from and/or written to in a well-known manner. Removable storage medium 1130 may be, for example, a floppy disk, magnetic tape, CD, DVD, SD card, etc.

The removable storage medium 1130 may be a non-transitory computer-readable medium having stored thereon computer executable code (i.e., software) and/or data (e.g., for implementing at least a portion of the subject matter described herein). The computer software or data stored on the removable storage medium 1130 is read into the device 1100 for execution by the processor 1110.

In alternative embodiments, secondary memory 1120 may include other similar means for allowing computer programs or other data or instructions to be loaded into the device 1100. Such means may include, for example, an external storage medium 1145 and an interface 1140. Examples of external storage medium 1145 may include an external hard disk drive or an external optical drive, or and external magneto-optical drive.

Other examples of secondary memory 1120 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 1130 and communication interface 1140, which allow software and data to be transferred from an external medium 1145 to the device 1100.

Device 1100 may include a communication interface 1140. The communication interface 1140 allows software and data to be transferred between device 1100 and external devices (e.g. printers), networks, or information sources. For example, computer software or executable code may be transferred to device 1100 from a network server via communication interface 1140. Examples of communication interface 1140 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing device 1100 with a network or another computing device.

Communication interface 1140 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 1140 are generally in the form of electrical communication signals 1155. These signals 1155 are preferably provided to communication interface 1140 via a communication channel 1150. In one embodiment, the communication channel 1150 may be a wired or wireless network, or any variety of other communication links. Communication channel 1150 carries signals 1155 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 1115 and/or the secondary memory 1120. Computer programs can also be received via communication interface 1140 and stored in the main memory 1115 and/or the secondary memory 1120. Such computer programs, when executed, enable the device 1100 to perform the various functions, such as those described herein.

In this description, the term “computer readable medium” is used to refer to any non-transitory computer readable storage media used to provide computer executable code (e.g., software and computer programs) to the device 1100. Examples of these media include main memory 1115, secondary memory 1120 (including internal memory 1125, removable medium 1130, and external storage medium 1145), and any peripheral device communicatively coupled with communication interface 1140 (including a network information server or other network device). These non-transitory computer readable mediums are means for providing executable code, programming instructions, and software to the device 1100.

In an embodiment that is implemented using software, the software may be stored on a computer readable medium and loaded into the device 1100 by way of removable medium 1130, I/O interface 1123, or communication interface 1140. In such an embodiment, the software is loaded into the device 1100 in the form of electrical communication signals 1155. The software, when executed by the processor 1110, preferably causes the processor 1110 to perform the inventive features and functions previously described herein.

In an embodiment, I/O interface 1123 provides an interface between one or more components of device 1100 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The device 1100 also includes optional wireless communication components that facilitate wireless communication over a voice network and/or a data network. The wireless communication components may comprise an antenna system 1160, a radio system 116, a baseband system 1170, or any combination thereof. In the device 1100, radio frequency (RF) signals are transmitted and received over the air by the antenna system 1160 under the management of the radio system 116.

In one embodiment, the antenna system 1160 may comprise one or more antennae and one or more multiplexors (not shown) that perform a switching function to provide the antenna system 1160 with transmit and receive signal paths. In the receive path, received RF signals can be coupled from a multiplexor to a low noise amplifier (not shown) that amplifies the received RF signal and sends the amplified signal to the radio system 1165.

In alternative embodiments, the radio system 1165 may comprise one or more radios that are configured to communicate over various frequencies. In one embodiment, the radio system 1165 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 1165 to the baseband system 1170.

If the received signal contains audio information, then baseband system 1170 decodes the signal and converts it to an analog signal. Then the signal is amplified and sent to a speaker. The baseband system 1170 also receives analog audio signals from a microphone. These analog audio signals are converted to digital signals and encoded by the baseband system 1170. The baseband system 1170 also codes the digital signals for transmission and generates a baseband transmit audio signal that is routed to the modulator portion of the radio system 1165. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 1160 where the signal is switched to the antenna port for transmission.

The baseband system 1170 is also communicatively coupled with the processor 1110. The central processing unit 1110 has access to data storage areas 1115 and 1120. The central processing unit 1110 is preferably configured to execute instructions (i.e., computer programs or software) that can be stored in the memory 1115 or the secondary memory 1120. Computer programs can also be received from the baseband processor 1160 and stored in the data storage area 1115 or in secondary memory 1120, or executed upon receipt. Such computer programs, when executed, enable the device 1100 to perform the various functions, such as those described herein. For example, data storage areas 1115 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A device for processing requests for merchant information, the device comprising:
a membership class assignment module adapted to assign a class of membership to a merchant;
a merchant verification module in electrical communication with the membership class assignment module and adapted to initiate a process of merchant verification upon at least receiving a request for merchant verification from the merchant;
a merchant information module in electrical communication with the merchant verification module and adapted to receive information associated with said merchant verification; and
an information request servicing module in electrical communication with the merchant information module and adapted to return information related to a selected merchant to a requesting merchant, wherein the information returned depends at least in part upon the class of membership associated with the requesting merchant.

2. The device of claim 1, wherein the membership class assignment module is adapted to assign a class of membership selected from the group consisting of basic membership and premium membership.

3. The device of claim 2, wherein the information request servicing module is further adapted to return basic merchant information if the class of membership associated with the requesting merchant indicates basic membership.

4. The device of claim 2, wherein the information request servicing module is further adapted to return detailed merchant information if the class of membership associated with the requesting merchant indicates premium membership.

5. The device of claim 4, wherein the detailed merchant verification information comprises one or more accounts associated with the selected merchant.

6. The device of claim 4, wherein the detailed merchant verification information comprises credit information associated with the selected merchant.

7. A computer-readable medium containing instructions which, when executed by a computer, perform a process comprising:
receiving an electronic request from a merchant for merchant profile verification;
referencing a set of data associated with said merchant;
selecting a set of one or more profile verification agencies to conduct at least a portion of said merchant profile verification, wherein the selection is determined based at least in part upon the set of data;
receiving results of the merchant profile verification from said set of one or more profile verification agencies; and
if the results indicate a successful merchant profile verification, presenting an electronic certification to said merchant.

8. The computer-readable medium of claim 7, wherein said presenting an electronic certification to said merchant comprises automatically updating each page of a set of product listing pages associated with said merchant so as to display an electronic certification icon.

9. The computer-readable medium of claim 7, wherein said presenting an electronic certification to said merchant comprises automatically updating a profile page associated with said merchant so as to display an electronic certification icon.

10. The computer-readable medium of claim 7, wherein said presenting an electronic certification to said merchant comprises providing a set of downloadable code, wherein the set of downloadable code is adapted to display a certification icon on a webpage.

11. The computer-readable medium of claim 10, wherein the code is further adapted to create a link to a webpage containing merchant information.

12. The computer-readable medium of claim 11, wherein the type of merchant information presented on the webpage is determined based at least in part upon a class of membership associated with a requesting merchant.
